(19) United States
(12) Patent Application Publication
(10) Pub. No.: US 2018/0249302 A1
(43) Pub. Date: Aug. 30, 2018

(54) EMERGENCY PUSH-TO-TALK CALL SETUP AT DIFFERENT PRIORITY LEVELS BASED ON SUPERGROUPS

(71) Applicant: MOTOROLA SOLUTIONS, INC, Chicago, IL (US)

(72) Inventors: MADHUSUDAN PAI, PALATINE, IL (US); PATRICK C. SCHRECK, ARLINGTON HEIGHTS, IL (US); BRIAN POE, CARY, IL (US); DANIEL J. MCDONALD, CARY, IL (US)

(21) Appl. No.: 15/853,654

(22) Filed: Dec. 22, 2017

Related U.S. Application Data
(60) Provisional application No. 62/464,516, filed on Feb. 28, 2017.

(51) Int. Cl. H04W 4/10; H04W 8/18; H04W 72/10; H04W 4/08; H04W 4/90; H04W 76/50

(52) U.S. Cl. CPC H04W 4/10; H04W 8/186; H04W 72/10; H04W 84/08; H04W 4/90; H04W 76/50; H04W 4/08

(57) ABSTRACT

A method is provided that sets up a Push-To-Talk (PTT) call. A first group is given a first value of an attribute, such as the priority of the PTT call or the state of the PTT call. A second group is given a second value of the attribute, such that the second value of the attribute is different from the first value of the attribute.

### BACKGROUND OF THE INVENTION

There are two common Push-To-Talk (PTT) features, Group Regrouping and Emergency PTT. Group Regrouping, also known as Linked Groups, is a feature that allows creating a regrouped supergroup, such that when any constituent group keys up there is a call on the supergroup which includes all participants of each constituent group.

Emergency PTT Call is a feature that allows prioritization of resources for the emergency call to preempt any lower priority in progress call. The emergency call itself cannot be preempted by another call.

In Land Mobile Radio (LMR) Systems, when an emergency call occurs on a constituent group of a supergroup, the given group is temporarily removed from the supergroup and an emergency is set up on that group alone. The console that created the supergroup is responsible for audio patching the Emergency group call via a new non-emergency call onto the supergroup.

Some LMR systems currently remove the constituent emergency group from the supergroup. Breaking the supergroup creates various complexities.

A first complexity is a temporary break in audio from an emergency user due to the removal of the emergency group from the supergroup.

A second complexity is when a second group in the supergroup goes into emergency state and there are two emergency talkers at the same time, for example one on each group. The console chooses one of the emergency user's audio to flow into the supergroup. This results in inconsistent end user experience because the end user's audio may sometimes flow to the supergroup, but sometimes just to the user's talkgroup. The end user is unaware of which groups are hearing his audio.

A third complexity is that there is latency in the audio as the console must audio patch the emergency audio from group to supergroup and vice versa.

### BRIEF DESCRIPTION OF THE SEVERAL VIEWS OF THE DRAWINGS

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

FIG. 1 depicts a call flow diagram in accordance with the prior art.

FIG. 2 depicts a call flow diagram in accordance with an exemplary embodiment of the present invention.

FIG. 3 depicts a call flow diagram in accordance with an exemplary embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

An exemplary embodiment of the present invention retains the supergroup in the event of an emergency on one or more constituent groups of the supergroup. This exemplary embodiment ensures that only group members of the groups in emergency are informed of emergency state of the group call which enables them to pre-empt existing non-emergency call participation, if any, and join the emergency group call whereas group members of other groups in the super group that are not in emergency state continue to see the call in non-emergency state, thereby enabling these users to move to other emergency calls or higher priority calls as appropriate.

This exemplary embodiment ensures that only group members of the groups in emergency are provided emergency priority resources, for example LTE Unicast GBR Bearers with the highest priority ARP invulnerable to preemption.

This exemplary embodiment ensures floor arbitration across the supergroup such that there is only one talker, and therefore a consistent end user experience. The talker is assured that audio is rendered to all users in the supergroup.

Call setup is preferably accomplished as follows. For an Emergency Call Setup on a Supergroup, a subset of affiliated users of the supergroup receive emergency notification based on their affiliated group in the supergroup. For example, when a user keys up in emergency on a constituent group of a supergroup, only affiliated users of the constituent group are notified of that group being online at emergency priority. Affiliated users of other groups in the supergroup are notified of that group being online at non-emergency priority.

A subset of affiliated users of the supergroup receive emergency LTE GBR Bearers based on their affiliated group in the supergroup. A PTT Server preferably asserts 3GPP Rx procedures to LTE PCRF to allocate emergency GBR Bearers only for affiliated users of the constituent group in emergency. The PTT Server asserts 3GPP Rx procedures to LTE PCRF to allocate non-emergency GBR Bearers for affiliated users of other groups in the supergroup.

Call promotion is preferably accomplished as follows. Promotion of existing supergroup call to emergency preferably happens as follows. When a user affiliated to a constituent group of the supergroup enters emergency state the PTT server preferably promotes the call to emergency by performing the following steps.

For a subset of affiliated users of the supergroup, resources are promoted to emergency priority. The remaining users continue to use previously allocated resources at non-emergency priority.

The PTT Server asserts 3GPP Rx procedures to LTE PCRF to modify GBR Bearers to emergency but preferably only for affiliated users of the constituent group in emergency.

Notifications are preferably sent out with emergency priority to affiliated members of the constituent group in emergency.

Floor arbitration is preferably accomplished as follows. Since the PTT Server preferably maintains a single call for the supergroup, as opposed to two or more calls in the existing art, the PTT Server preferably applies floor arbitration across all participants of the supergroup call. If there are two emergency talkers affiliated to different groups of a supergroup, the treatment is identical to two emergency talkers on a single group call.

Floor control priority is preferably accomplished as follows. Generally a system uses user-assigned priority level for determining floor control within a call. However, when grouping high priority groups, such as emergency groups, and low priority groups, such as non-emergency linked groups, together, there is value in prioritizing floor control for users in the high priority group over users in the low priority group. This is true regardless of their individual user priority. For example, a radio in the emergency group could interrupt a transmitting radio from the non-emergency group, even if the user in the emergency group had a lower user priority.

Exemplary embodiments thereby combine emergency and patch talkgroup features. One novel feature is that call setup from different sub-groups of a super group according to different affiliated priority manipulates floor control and/or bearer resource allocation. In addition, exemplary embodiments distribute call setup signaling messages and audio to different sub-groups of a super group with different notification according to different affiliated priority in one call.

An exemplary embodiment preserves super-groups despite an emergency call on a constituent group. This is preferably done by signaling the call with different priority to different sub-groups.

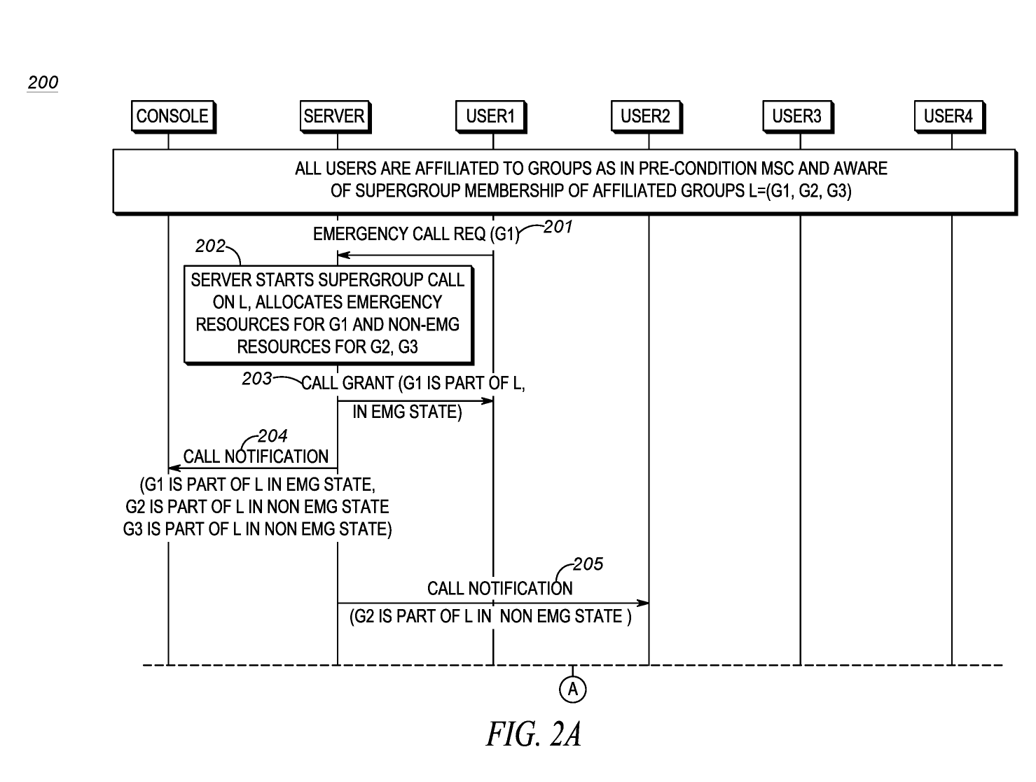

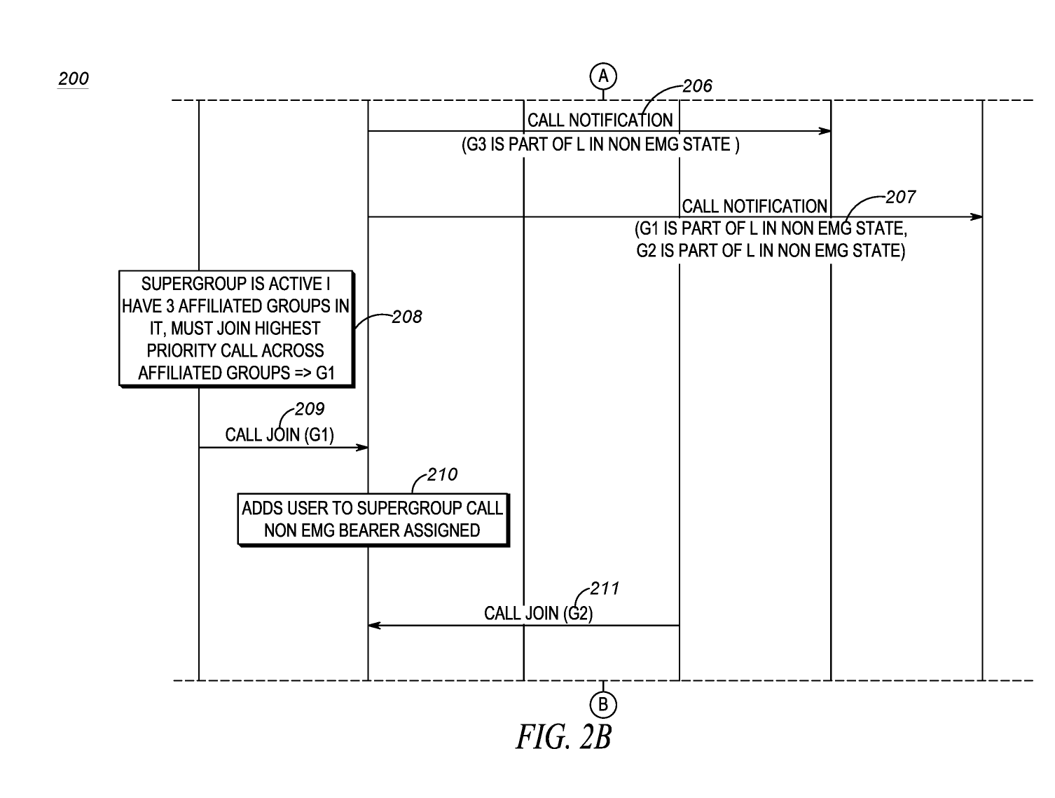

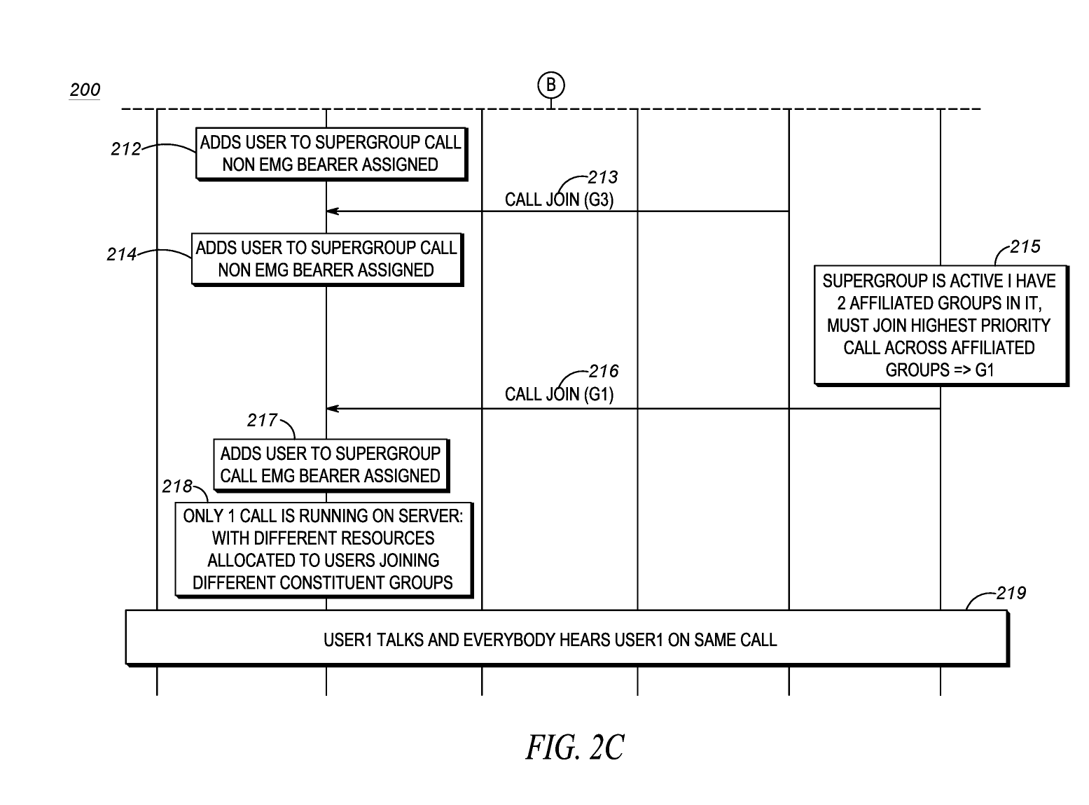

One exemplary embodiment of the present invention is when the server in FIG. 2 sends the state of a first call on supergroup L to affiliated users of g1, g2, g3. In this exemplary embodiment, users affiliated to g1 only are told there is a call on g1 as part of supergroup L in emergency state. Users affiliated to g2 only are told there is a call on g2 as part of supergroup L in non-emergency state. Users affiliated to g3 only are told there is a call on g3 as part of supergroup L in non-emergency state.

Users affiliated to g1 and g2 are told there is a call on g1 as part of supergroup L in emergency state and g2 as part of same supergroup L in non-emergency state and users affiliated to g1, g2 and g3 are told there is a call on g1 as part of supergroup L in emergency state, g2 as part of same supergroup L in non-emergency state and g3 as part of same supergroup L in non-emergency state.

One general idea is therefore sending the state of the same call differently to different subsets of participants. This state of the call sent to the participant is then used in the following manner.

At the participant's PTT client, it is determined whether that participant must join the call. At the PTT server, it is determined the type of resource allocated to that participant. At the PTT server it is differentiated sets of participants access to floor.

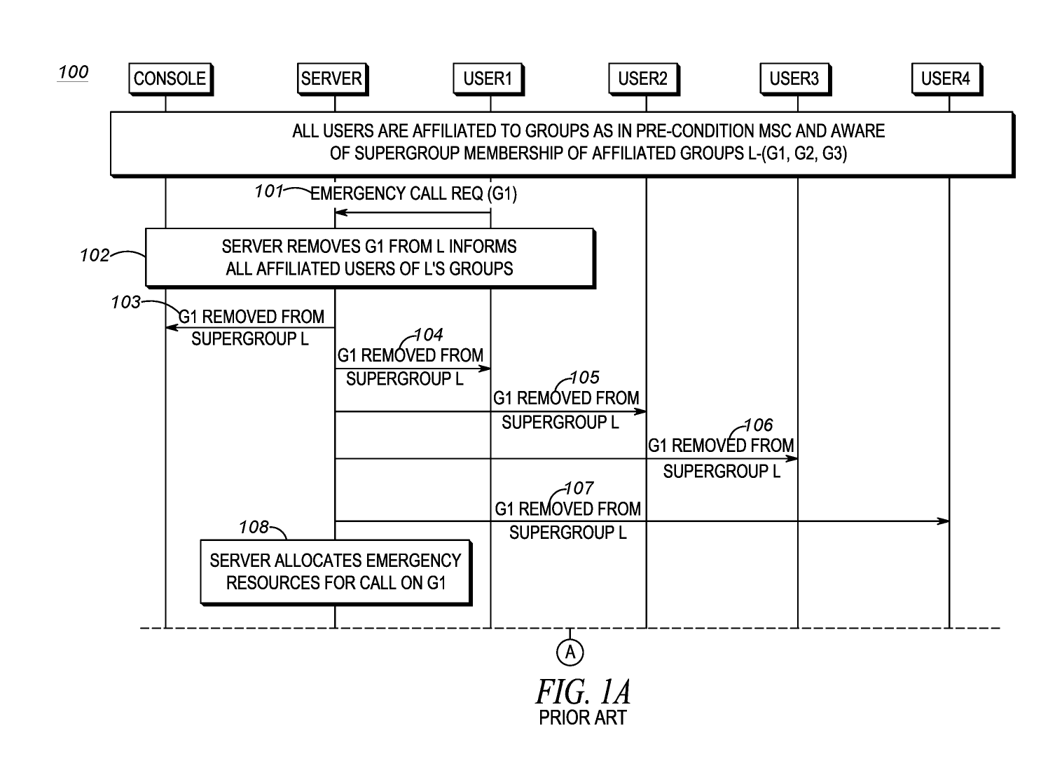

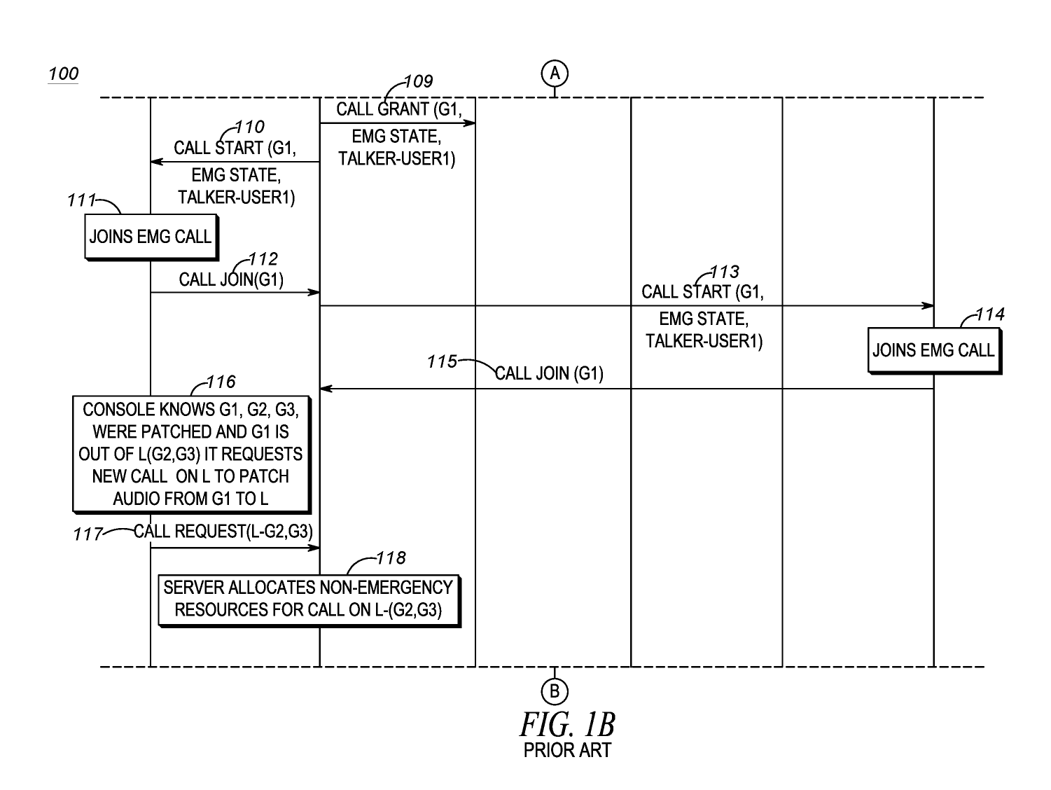

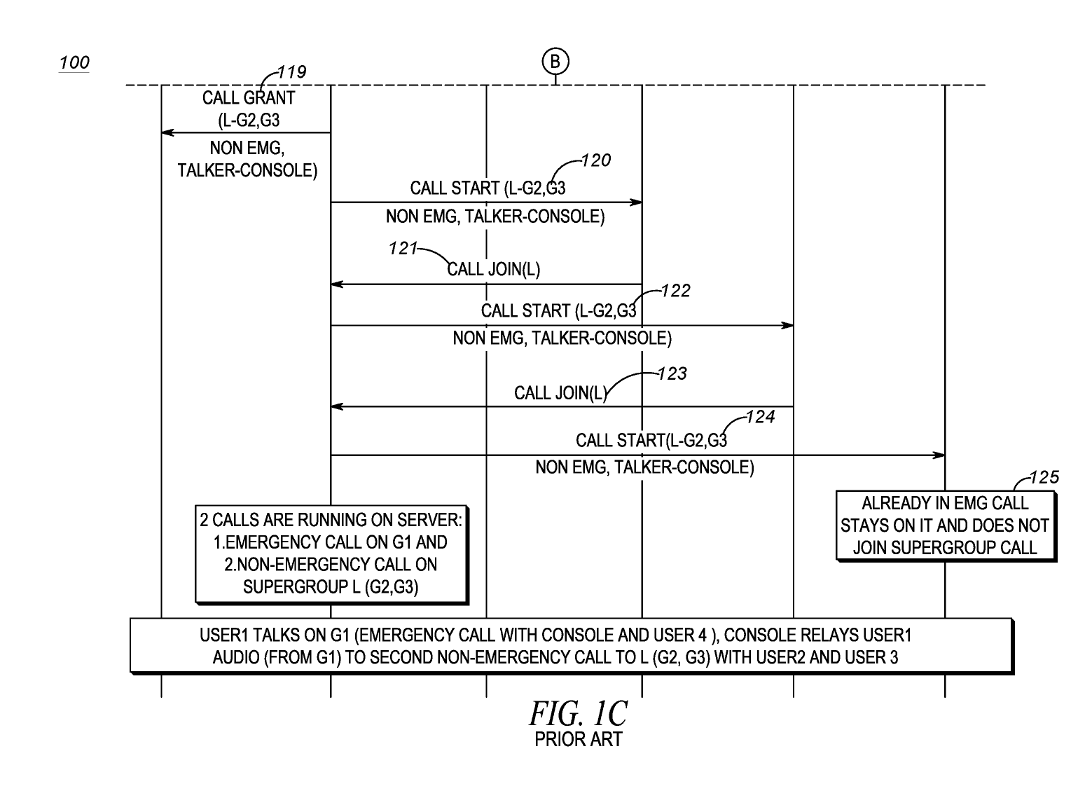

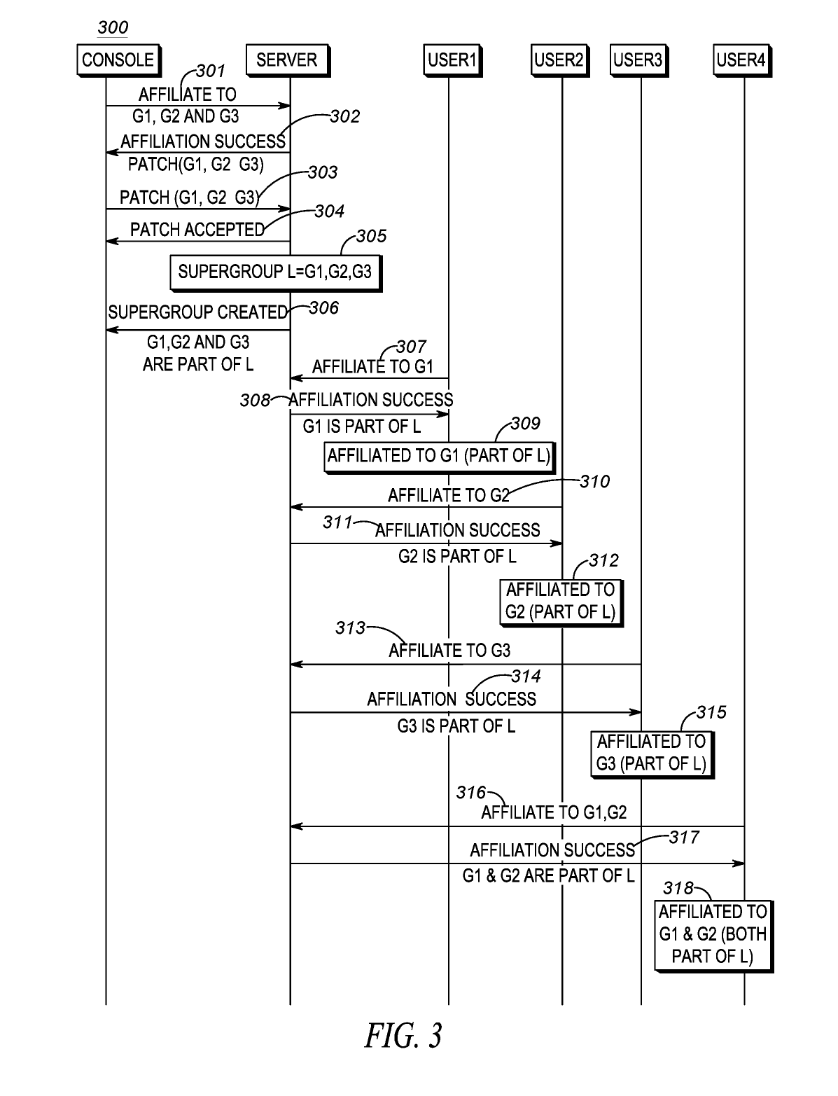

An exemplary embodiment can be further understood with reference to FIGS. 1-3. FIG. 1 depicts a call flow diagram 100 in accordance with the prior art. In the prior art, all users are affiliated to groups as in pre-condition MSC of FIG. 3 and are aware of supergroup membership of affiliated groups. In this exemplary embodiment, supergroup L comprises group 1 (g1), group 2 (g2), and group 3 (g3).

User 1 sends emergency call request 101 for g1 to the server. The server removes (102) g1 from L ad informs all affiliated users of L's groups.

The server sends g1 removed from supergroup L message 103 to the console and g1 removed from supergroup L message 104 to user 1. The server also sends g1 removed from supergroup L message 105 to user 2, g1 removed from supergroup L message 106 to user 3, and g1 removed from supergroup L message 107 to user 4.

The server allocates (108) emergency resources for a call on g1. The server then sends call grant message 109 to user 1. Call grant message 109 preferably includes the group g1, the emergency state, and that the talker is user 1. The server also sends call start message 110 to the console. Call start message 110 preferably include the group g1, the emergency state, and that the talker is user 1.

The console then performs processing to join (111) the emergency call. This includes sending call join message 112 to the server. Call join message 112 includes the group g1. The server sends call start message 113 to user 4. Call start message 113 preferably includes the group g1, the emergency state, and that the talker is user 1.

User 4 then joins (114) the emergency call. User 4 sends call join message 115 to the server. Call join message 115 includes the group g1.

The console knows (116) that g1, g2, and g3 were patched and that g1 is out of supergroup L, which now includes g2 and g3. The console requests a new call on L to patch audio from g1 to L. The console sends call request message 117 to the server. Call request message 117 includes a variable that supergroup L includes g2 and g3.

The server allocates (118) non-emergency resources for the call on supergroup L. The server sends call grant message 119 to the console. Call grant message 119 includes variables that L is comprised of g2 and g3, that this is a non-emergency call, and that the talker is the console. The server sends call start message 120 to user 2. Call start message 120 includes that the supergroup L comprises g2 and g3, that this is a non-emergency call, and that the talker is the console. User 2 sends call join message 121 to the server, which includes the supergroup L.

The server sends call start message 122 to user 3. Call start message 122 includes that the supergroup L comprises g2 and g3, that this is a non-emergency call, and that the talker is the console. User 3 sends call join message 123 to the server, which includes the supergroup L.

The server sends call start message 124 to user 4. Call start message 124 includes that the supergroup L comprises g2 and g3, that this is a non-emergency call, and that the talker is the console. User 4 determines (125) that it is already in an emergency call and stays on the current emergency call and does not join the supergroup call.

At this point two calls are running on the server, an emergency call on g1 and a non-emergency call on supergroup L. User 1 talks on g1, which is an emergency call with the console and user 4. The console relays user 1 audio from g1 to a second non-emergency call to super group, which includes g2 and g3, with user 2 and user 3.

FIG. 2 depicts a call flow diagram in accordance with an exemplary embodiment of the present invention. In this exemplary embodiment, all users are affiliated to groups as in pre-condition MSC of FIG. 3 and are aware of supergroup membership of affiliated groups. In this exemplary embodiment, supergroup L comprises group 1 (g1), group 2 (g2), and group 3 (g3).

User 1 sends emergency call request 201 for g1 to the server. The server starts (202) a supergroup on supergroup L. This includes allocating emergency resources for g1 and non-emergency resources for g2 and g3. The server sends call grant message 203 to user 1. Call grant message 203 includes an indication that g1 is part of L. which is in emergency state.

The server sends call notification message 204 to the console. Call notification message 204 includes an indication that g1 is part of supergroup L that is in emergency state, g2 is part of L that is in a non-emergency state, and that g3 is part of L that is in a non-emergency state. The server sends call notification message 205 to user 2. Call notification message 205 includes an indication that g2 is part of L in a non-emergency state. The server sends call notification message 206 to user 3. Call notification message 206 includes an indication that g3 is part of L in a non-emergency state. The server sends call notification message 207 to user 4. Call notification message 207 includes an indication that g1 is part of L in an emergency state and that g2 is part of L in a non-emergency state.

The console determines (208) that the supergroup L is active and that there are three affiliated groups in supergroup L. The console determines that is should join the highest priority call across the affiliated groups, which in this exemplary embodiment is g1.

The console sends call join message 209 to the server. Call join message 209 includes g1. The server adds (210) the user to the supergroup call with an emergency bearer assigned.

User 2 sends call join message 211, including g2, to the server. The server adds (212) the user to the supergroup call with a non-emergency bearer assigned.

User 3 sends call join message 213, including g3, to the server. The server adds (214) the user to the supergroup call with a non-emergency bearer assigned.

User 4 determines (215) that supergroup L is active and has two affiliated groups in it and that user 4 must join the highest priority call across affiliated groups, which in this case is g1. User 4 sends call join message 216, including group g1, to the server.

The server adds (217) user 4 to the supergroup call with an emergency bearer assigned. The server determines (218) that only one call is running on the server, with different resources allocated to users depending on the different constituent groups that the user joins. At this point, user 1 talks (219) and all users hear user 1 on the same call.

FIG. 3 depicts a call flow diagram 300 in accordance with an exemplary embodiment of the present invention.

The console sends affiliation message 301 to the server to affiliate g1, g2, and g3. The server preferably responds with affiliation success message 302.

The console sends patch message 303, which includes g1, g2, and g3. The server responds with patch accepted message 304. Supergroup L is now formed (305) at the server. The supergroup L includes g1, g2, and g3. The server sends supergroup created message 306 to the console. Supergroup created message 306 includes an indication that g1, g2, and g3 are a part of supergroup L.

User 1 sends affiliation message 307 to the server. Affiliation message 307 is a request for user 1 to affiliate to g1. The server sends affiliation success message 308 to user 1, which indicates that the request was successful and g1 is a part of supergroup L. User 1 now realizes (309) that user 1 is affiliated to g1 as part of supergroup L.

User 2 sends affiliation message 310 to the server. Affiliation message 310 is a request for user 2 to affiliate to g2. The server sends affiliation success message 311 to user 2, which indicates that the request was successful and g2 is a part of supergroup L. User 2 now realizes (312) that user 2 is affiliated to g2 as part of supergroup L.

User 3 sends affiliation message 31313 to the server. Affiliation message 313 is a request for user 3 to affiliate to g3. The server sends affiliation success message 314 to user 3, which indicates that the request was successful and g3 is a part of supergroup L. User 3 now realizes (315) that user 3 is affiliated to g3 as part of supergroup L.

User 4 sends affiliation message 316 to the serer. Affiliation message 316 is a request to affiliate to groups g1 and g2. The server sends affiliation success message 317 to user 4, which indicates that the affiliation request was successful and that g1 and g2 are a part of supergroup L. User 4 now realizes (318) that user 4 is affiliated to g1 and g2 as part of supergroup L.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized electronic processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising an electronic processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method to setup a Push-To-Talk (PTT) call which is signaled at different priority for different sets of call participants, the method comprising:
giving a first group a first priority; and
giving a second group a second priority.

2. The method of claim 1, wherein the first group is an emergency group.

3. The method of claim 2, wherein the second group is a linked group priority.

4. The method of claim 1, wherein the first priority and the second priority apply to call pre-emption.

5. The method of claim 4, wherein the call preemption is applied differently based on the first priority and the second priority.

6. The method of claim 4, wherein a first call with the first priority is higher than a second call with the second priority, and wherein the second call is pre-empted by the first call.

7. The method of claim 6, wherein participants in the second call join the first call.

8. The method of claim 7, wherein the step of preempting the second call and joining the first call comprises applying different preemption and joining to each set of participants based on the priority each set of participants receives.

9. The method of claim 1, wherein the first group is created based on group affiliation.

10. The method of claim 9, wherein the group affiliation comprises a super-group that comprises multiple groups.

11. The method of claim 1, wherein the first priority relates to floor control priority.

12. The method of claim 1, wherein the second priority relates to floor control priority.

13. A method comprising initiating an emergency call on a supergroup, wherein the supergroup comprises an emergency group and at least one non-emergency group, and wherein only the emergency group is elevated to emergency status.

14. The method of claim 13, wherein elevation to emergency status comprises a notification to affiliated participants of the emergency group that the call is online with emergency status.

15. The method of claim 14, the method further comprising the step of allocating emergency resources to the affiliated participants of the emergency group.

16. The method of claim 13, wherein an existing non-emergency supergroup call is elevated to emergency status due to a user affiliated to a non-emergency group enters an emergency state.

17. A method to setup a Push-To-Talk (PTT) call, the method comprising:
giving a first group a first value of an attribute; and
giving a second group a second value of the attribute, wherein the second value of the attribute is different from the first value of the attribute.

18. The method of claim 17, wherein the attribute is the priority of the PTT call.

19. The method of claim 17, wherein the attribute is the state of the PTT call.

20. The method of claim 19, wherein the state of the PTT call is an emergency call.
